(19) United States
(12) Patent Application Publication
(10) Pub. No.: US 2004/0175455 A1
(43) Pub. Date: Sep. 9, 2004

(54) Injection molding clamping system

(75) Inventors: Thierry Fabozzi, Ann Arbor, MI (US); Leon Salenbien, Dundee, MI (US)

Correspondence Address: Eric J. Sosenko, BRINKS HOFER GILSON & LIONE, P.O. Box 10395, Chicago, IL, 60610, US

(73) Assignee: Uniloy Milacron Inc.

(21) Appl. No.: 10/383,488

(22) Filed: Mar. 7, 2003

(51) Int. Cl. B29C 45/64

(52) U.S. Cl. 425/595

(57) ABSTRACT

A plastic injection molding station having a mold assembly with a plurality of first mold sections and a plurality of second mold sections. Each of the first mold portions adapted to cooperate with one of the second mold portions so as to define a plurality of mold cavities, the mold cavities being of equal distance across the length of the mold assembly and further defining a shape of an article to be injection molded therein. The first mold portions and second mold portions are adapted for relative movement between an engaged position where the first and second mold portions define the mold cavities and a disengaged position where the first and second mold portions are separated from one another. The station also includes a locking assembly adapted to lock the first and second mold portions together in the engaged position. The locking assembly applies a distributed locking force to the mold assembly when in the engaged position whereby each of the mold cavities of the mold assembly is subjected to substantially the same locking force. The locking assembly including a first member in the station for movement between a locked position and an unlocked position, the locking assembly further including an actuator coupled to the first member and adapted to cause movement of the first member between the locked and unlocked positions. A frame at least partially supporting the mold assembly and said locking assembly and an injection means for injecting plastic resin into the mold cavities through one of the first and second mold portions.

### BACKGROUND

1. Field of the Invention

The present invention generally relates to injection molding machines and, more particularly, to a clamping system for an injection molding machine

2. Description of the Related Art

Injection molding is a commonly used manufacturing method for mass-producing plastic components. During this method, heated plastic resin is injected at high pressure into a mold, allowed to cool and solidify in the shape of the desired component.

Molds used in plastic injection molding are generally of heavy-duty construction because of the high pressures they must withstand. The machinery that the molds fit into also must be very robust to withstand these pressures. One drawback of high injection molding pressures is that during molding, the injection pressure can result in the partial opening of the molds. Because of the high injection pressures, the mold is typically held together during the injection step by hydraulic or mechanical forces. Generally, machines are sized by the amount of molding or clamp pressure (tonnage) required to hold the mold together.

Clamp pressure alone does not always prevent mold separation or opening. Since the mold components, such as cavity molds and core rods or mold halves, are often carried on beams extending between tie rods, the high molding pressures can cause deflection of these beams. Beam deflection can be either exhibited by an upward bow in the beam at its center (when clamping forces are applied at its ends) or by an upward bowing of the beam's ends (when clamping forces are applied in the center of the beam).

To reduce beam deflection, and the resulting dissimilar application and distribution of compensation forces across the length of the mold, beams are shaped to provide increased resistance to deflection at the desired locations. A shaped beam may accordingly be thicker in its middle or its ends, depending on where force is to be applied. Even so, beam deflection to a certain extent will still occur and exist.

For the machine manufacturer, this means that the various components of each machine are customized to the clamping tonnage of that particular machine. Common components, generally, cannot be designed for a variety of differing tonnage machines, unless common components are designed for the maximum tonnage application. This is not economically desirable since it increases machine costs. The various components mentioned above include tie bars and the reinforced beams used at the top of the machines. In higher tonnage machines, the increased size of these components increases the purchase cost of the machine, requires more energy to operate, takes up space in a manufacturing facility, increases the overall machine size, and to some extent, slows the cycle time of the machine.

In view of the foregoing, it is clear that there exists a need for an injection molding machine design that enable use of a greater amount of common components between various tonnage sizes.

### SUMMARY OF THE INVENTION

In achieving the above and other objects, the present invention provides a novel mold compensation and locking system for an injection molding machine. The mold compensation and locking system operates to balance the forces across the mold width and at each individual mold cavity so the forces experienced at any mold cavity are generally equal, as a result, the likelihood of beam deflection is reduced and more consistent products are manufactured.

As mentioned above, the force created when the molten plastic resin is injected into the mold cavity, hereinafter called the “injection force”, is a very high force. Due to this force, there is a tendency for the molds to separate when the plastic is injected. To counter that, opposing or compensating measures must be taken.

The mold compensating and locking system of the present invention can be accomplished in several different configurations. In one embodiment, locking arms are hingedly secured adjacent a lower or fixed mold half. The locking arms span the length or substantially the length of the mold. The arms rise toward an upper mold portion and are provided with features that engage with at least a portion of the upper mold. The features on the locking arm do not need to extend entirely across the width of the mold in order to lock it closed.

In addition to locking, to provide equal force at each mold cavity, a compensation force is applied to the top of each mold cavity while the mold is locked closed. One configuration that may be used to apply this compensation force is a piston, located above each cavity, that exerts pressure in the direction opposing the injection force.

By applying the above forces where they are required and evenly across the mold (via the locking system), wear of the mold will be reduced. By using the locking system mentioned above, the injection molding machine is not as sensitive to the tonnage requirement of a particular application. This allows various components of the injection molding machine to be commonly used for a wider range of tonnage machines than is currently possible. Therefore, a manufacturer will not need to have as many different tonnage machines as with prior art platen and tie bar designs.

Additional benefits and advantages of the present invention will become apparent to those skilled in the art to which the present invention relates from the subsequent description of the preferred embodiments and the appended claims, taken in conjunction with the accompanying drawings.

### BRIEF DESCRIPTION OF THE DRAWINGS

FIG. 1 is a side sectional view of an injection molding station embodying the principles of the present invention and illustrating the molding station in the fully open position;

FIG. 2 is a partial sectional view generally taken along line 2-2 of FIG. 1;

FIGS. 3 and 4 are side sectional views illustrating stages of the mold closing sequence, generally after the stages seen in FIGS. 1 and 2;

FIG. 5 is a side sectional view similar to FIG. 4 illustrating forces involved during the molding process;

FIGS. 6, 7 and 8 are partial side sectional views illustrating stages of the mold opening sequence; and

FIG. 9 is a partial sectional view generally taken along line 9-9 in FIG. 8.

### DETAILED DESCRIPTION OF THE PREFERRED EMBODIMENT

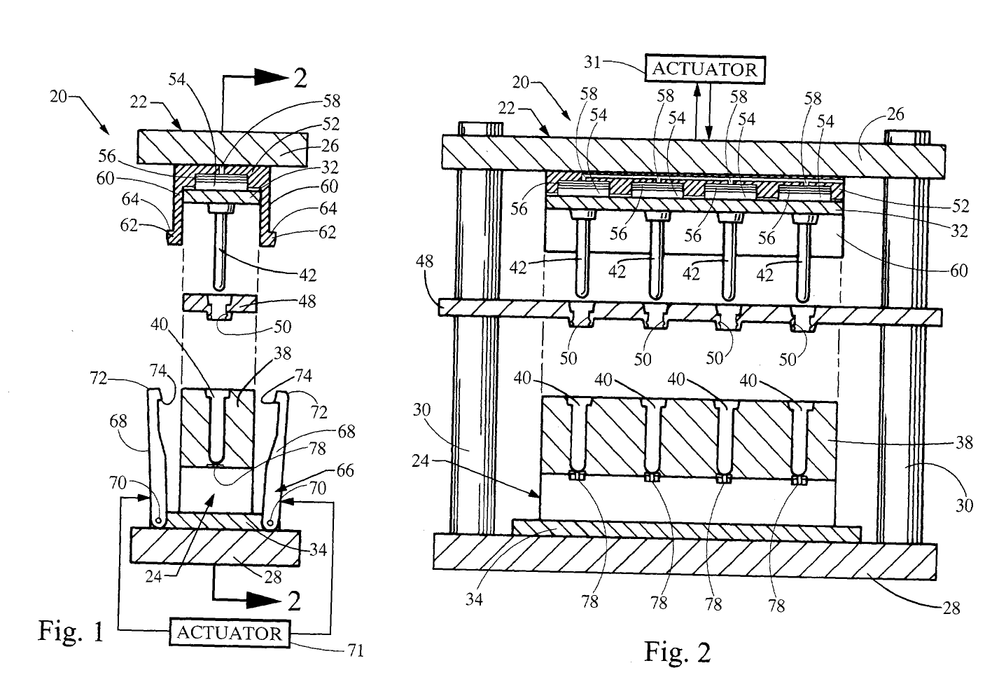

Referring now to FIGS. 1 and 2, an injection mold station 20 is shown therein in the fully open position prior to the start of an injection molding cycle. The injection molding station 20 is preferably part of an injection molding machine or one of several stations in an injection blow molding machine. Other aspects of these types of machines (such as an injection ram, resin feed hopper, take-out mechanism, rotary table, other stations, etc.) are not illustrated herein, it being understood that individuals skilled in the field will readily appreciate the need for and location of such components depending on the particular type of machine into which the molding station 20 is incorporated.

As generally illustrated, the primary components of the mold station 20 include a support frame 22 and a mold assembly 24.

The support frame 22 generally includes an upper platen or beam 26 coupled to a lower platen or beam 28 through a pair of tie rods 30. An actuator (not shown), which may be mechanical, pneumatic or hydraulic, is coupled to the upper beam 26 so as to cause a lowering of the upper beam 26, guided by the tie rods 30, toward the lower beam 28 and a subsequent rising thereof. As will be further described below, respectively mounted by conventional means to the upper and lower beams 26, 28 are a top plate 32 and a bottom plate 34.

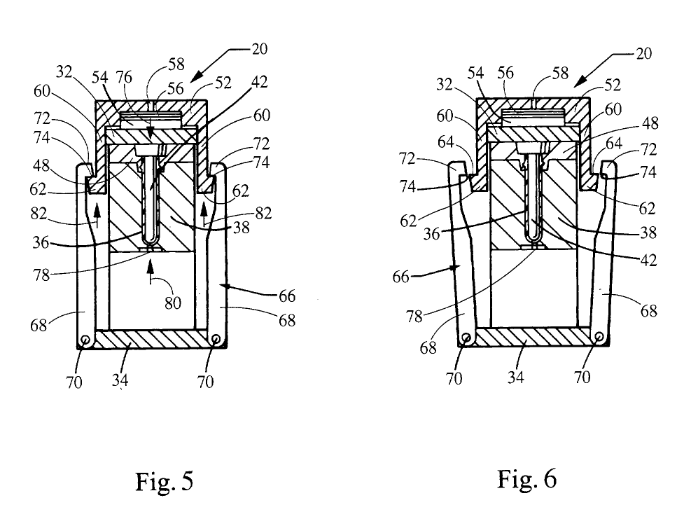

Also positioned between the upper and lower beams 26, 28 is the mold assembly 24 mentioned above. The mold assembly 24 may be of any of the variety of configurations known in the industry. As illustrated and described herein, the mold assembly 24 is configured for the injection molding hollow articles, known as preforms 36 (seen in FIGS. 4-9), subsequently used in the blow molding of plastic bottles. In order to injection mold the hollow preforms 36, the mold assembly 24 includes a lower mold block 38 defining one or more mold cavities 40. Respectively received into each of the cavities 40 is a mold core 42. As such, the surfaces forming the cavities 40 will define the exterior surfaces of the performs 36 and the exterior surfaces of the mold cores 42 will define the interior surfaces of the perform 36. The mold block 38 may be directly secured to the lower beam 28 mounting plate 44 through additional or other means. The mold cores 42 are carried by a top plate 32, which in turn mounts the mold cores 42 to the top plate 32 and the upper beam 26.

Located between the mold block 38 and the mold cores 42 and also supported by the support frame 22, is a thread plate 48. The thread plate 48 has defined therethrough a series of passageways 50 whose surfaces define threads on the molded preforms 36. As further discussed below, during lowering of the mold cores 42 into the cavities 40, the thread plate 48 is positioned so that the cores 42 pass through the passageways 50 of the thread plate 48. Thereafter, the thread plate 48 is lowered with the cores 42. Upon retraction of the cores 42, the thread plate 48 is initially retracted within the cores 42, which are subsequently retracted out of the passageways 50 of the thread plate 48. Once fully retracted, the preforms 36 are carried by their threads in the thread plate 48, to subsequent stations of the machine as dictated thereby, and removed therefrom upon the thread plate 48 separating into two halves along a longitudinal parting line therethrough or other mechanism.

The top plate 32 is carried within by an upper central support member 52 which is in turn mounted to the upper beam 26. Defined within the upper central support member 52 at a location corresponding with each mold core 42 is a cylinder 54 within which is received a piston 56. The piston 56 is in close fit relation with the cylinder 54 and is moveable therein so as to compress a medium such as air located between the piston 56 and the upper central support member 52. In order to pressurize the pistons 56 the rear faces of the pistons 56 are coupled via passageways 58 to a pressurizing medium and source (not shown), which may be hydraulic, pneumatic or other suitable medium. In this manner, the piston 56 provides a compensation force equal or greater to and in an opposite direction from the force exerted by the plastic resin as it is injected at high pressure into the mold cavity 40 defined between the cores 42 and the mold block 38.

As seen in FIG. 1, the upper central support member 52 is provided with a pair of opposing arms 60. The arms 60 extend from the central support member 52 in a direction generally perpendicular thereto. As seen in FIG. 1, the arms 60 can be viewed as extending downward from the side edges of the central support member portion 52. It is further noted that the arms 60 are provided for along the entire length of the central portion 52. Preferably, the arms 60 are provided at least along the length of the mold assembly 24 corresponding to the length over which the mold cavity 40 are provided. As will be further discussed below, the distal ends 62 of the arms 60 respectively, are each provided with a laterally, outwardly extending shoulder 64, respectively.

The arms 60 and shoulders 64 mentioned above form part of a locking assembly 66. The locking assembly 66 additionally includes a pair of lock arms 68 which are moveably connected at points 70 to the bottom plate 34. The arms 68 can be moved through their permitted degree of rotation by suitable actuation means (not shown) which may include pneumatic actuators, electric motors or electromechanical actuators. Such actuators being well within the skill of those familiar with this field are accordingly not further described herein.

The distal ends 72 of the arms 68 are provided inwardly extending shoulders 74. The shoulders 74 are formed in a complementary manner to shoulders 64 mentioned above. The formation of the shoulders 64, 74 in complementary fashion allows for engagement of the corresponding shoulders with each other during locking of the locking assembly 66. The procedure for locking and unlocking of the locking assembly 66 is further discussed below in connection with the overall operation of the mold station 20.

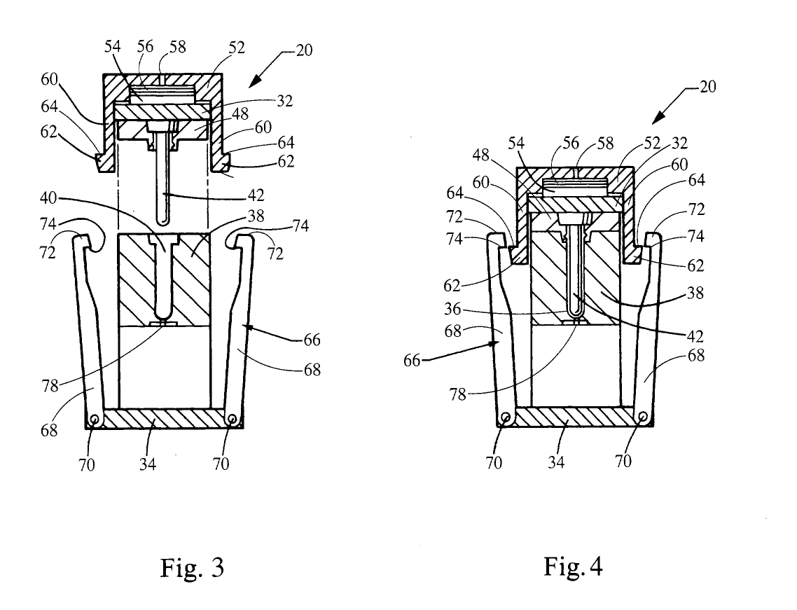

A single operating cycle for the mold station 20 is illustrated in successive steps in FIGS. 1, 3, 4, 5, 6, 7 and 8 and will now be described. In general, initiation of the operating cycle begins with the various components of the mold station 20 its open or disengaged position, generally illustrated in FIG. 1. In its opened position, the mold station, the actuator coupled to the upper beam 26 is retracted withdrawing the upper beam 26, top plate 32 and mold cores 42 in their retracted position out of away from the lower mold block 38 in the cavities 40 defined therein. The thread plate 48 is linked for movement with the upper beam 26, however movement of the thread plate 48 is less than that of the top plate 32 so as to allow for withdrawal of the mold cores 42 through the passageways 50 defined in the thread plate 48. It should also be noted that in FIG. 1 the lower arms 68 are rotated about pivot 70 into their laterally outward most position by suitable actuators (not shown).

Upon initial closing of the mold assembly 24, the actuator causes the upper beam 26, top plate 32 and mold cores 42 to be lowered to a point where the mold cores 42 extend through the passageways 50 defining the thread plate 48 and where the top plate 32 contacts and engages the thread plate 48. With the mold cores 42 each extended to a respective passageway 50 and a thread plate 48, continue downward movement of the upper beam by its corresponding actuator causes the thread plate 48 and the mold cores 42 along with the upper central support member 52 to be lowered in unison toward the lower mold block 38.

Once completely lowered, the mold cores 42 are received in their corresponding cavities 40 of the mold block 38 and the thread plate 48 comes into contact with the upper surface of the mold block 38. This is illustrated in FIG. 4. Since the locking assembly 66 is not yet been actuated, the shoulders 64 of the upper lock arms 60 and the shoulders 74 of the lower lock arms 68 are not yet engaged with one another but it can be seen from the figure that the length of the arms 60, 68 and the providing of the respective shoulders 64, 74 is provided such that the shoulders 64, 74 will engage one another upon inward movement or actuation of the lower arms 68.

Once the upper beam 26 has been fully lowered, the lower arms 68 of the lock assembly 66 are actuated so as to move inward to engage the upper arms 60 of the locking assembly 66. Prior to the injection of molten resin into the mold cavities defined between the external surfaces of the mold cores 42 and the internal surfaces of those portions defining the cavities 40 in the mold blocks 38, a pressurized medium is provided from a source via passageways 58 causing downward movement of the pistons 56 which in turn causes compression of air or other medium located within the cylinders 54 in the space between the pistons 56 and the upper surface of the top plate 32. Since the pistons 56 are each provided at a location directly corresponding with a mold core 42, pressurization of the pistons 56 causes the exertion of a compensation force in the direction indicated by arrow 76 and generally centered with respect to the mold cavities 40.

Simultaneously with the application of the compensation force 76 molten plastic resin is injected under high pressure through a gate 78 so as to fill the mold cavity about the mold cores 42 thereby forming the preforms 36. An injection force 80 is generated generally centrally along each cavity 40 as a result of the high pressure injection of the plastic resin. In that the compensation force 76 has been previously or simultaneously applied to the mold station 20 the forces 76, 80 operate so as to generally cancel one another. Preferably the compensation force 76 is greater than the injection force 80. In this manner, the compensation force 76 minimizes any mold separation which might occur between the mold block 38, the thread plate 48 or the top plate 32.

In addition to the compensation force 76 the engagement of the lock assembly 66 provides a locking force that is evenly distributed across the length and width of the mold block 38. In that the width of the arms 60 corresponds to the length of the mold block 38, locking forces (generally designated by arrows 82) are equally distributed along the mold assembly 24 and across the mold cavities 40.

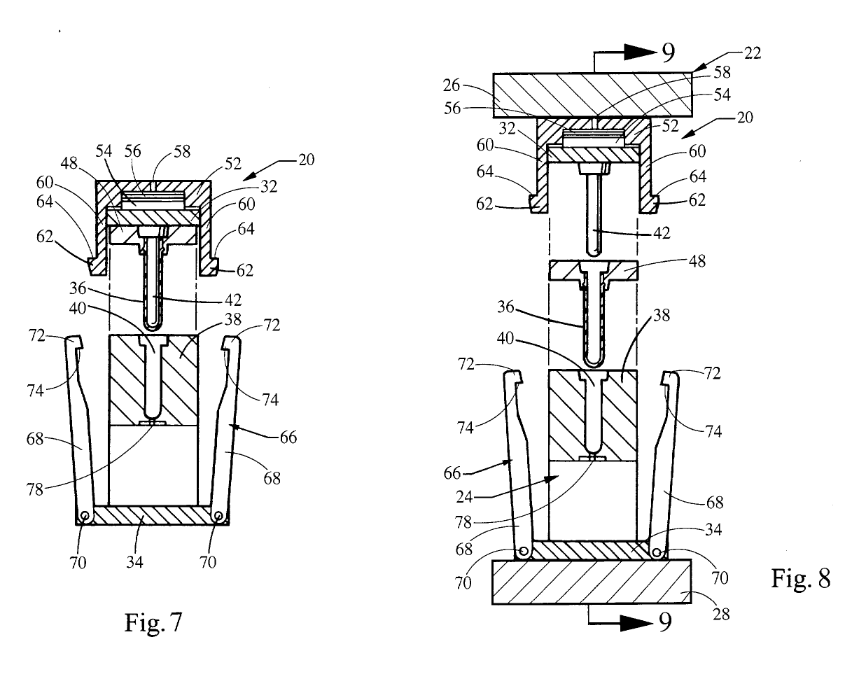

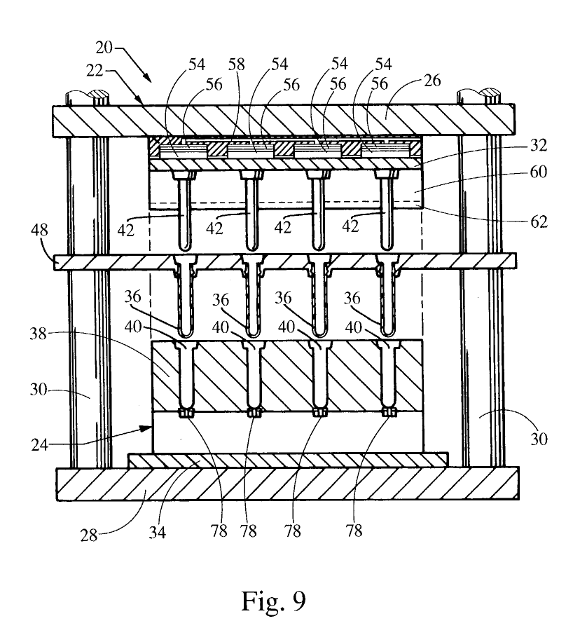

Once the preform 36 has solidified to a point it can support its own structure, the locking assembly 66 disengages with the lower arms 68 being moved outward relative to the upper arm 60 such that the shoulders 64, 74 disengage and clear one another. Thereafter, as seen in FIG. 7, an actuator withdraws the thread plate 48, top plate 32 and central support member 52 upward in turn causing the withdrawal of the mold cores 42 and the preforms 36 from the cavities 40. At a point where the preforms 36 have cleared the cavities 40, the thread plate 48 reaches its limit of movement and thereafter the mold cores 42, top plate 32 and central support member 52 continue to be retracted into their fully retracted position with the upper beam 26 as indicated in FIG. 8. This is further illustrated in FIG. 9.

Thereafter, the preforms 36 may be carried by the thread plate 48 to another station in a molding machine for further processing of the preforms 36 or, alternatively, the preforms 36 may be removed from the thread plate 48 by conventional mechanisms and means. Once the preforms 36 have been, removed from the thread plate 48 or a thread plate 48 without preforms 36 has been properly located relative to the mold cores 42 and cavities 40, the operational cycle described above proceeds to repeat itself with additional preforms thereafter being manufactured.

The foregoing discussion discloses and describes one preferred embodiment of the invention. One skilled in the art will readily recognize from such discussion, and from the accompanying drawings and claims, that changes and modifications can be made to the invention without departing from the true spirit and fair scope of the invention as defined in the following claims. The invention has been described in an illustrative manner, and it is to be understood that the terminology which has been used is intended to be in the nature of words of description rather than of limitation.

We claim:

1. A plastic injection molding station comprising:
a mold assembly having a plurality of first mold sections and a plurality of second mold sections, each of said first mold portions adapted to cooperate with one of said second mold portions so as to define a plurality of mold cavities, said mold cavities being provided equidistantly across the length of said mold assembly and further defining a shape of an article to be injection molded therein, said first mold portions and said second mold portions adapted for relative movement between an engaged position where said first and second mold portions define said mold cavities and a disengaged position where said first and second mold portions are separated from one another;
a locking assembly adapted to lock said first and second mold portions together in said engaged position, said locking assembly applying a distributed locking force to said mold assembly when in said engaged position whereby each of said mold cavities of said mold assembly is subjected to substantially the same locking force, said locking assembly including a first member in said station for movement between a locked position and an unlocked position, said locking assembly further including an actuator coupled to said first member and adapted to cause movement of said first member between said locked position and said unlocked position;
a frame at least partially supporting said mold assembly and said locking assembly; and
injection means for injecting plastic resin into said mold cavities through one of said first and second mold portions.

2. The plastic injection molding station as set forth in claim 1 wherein said first member of said locking assembly is provided with a width corresponding to the length of said mold assembly.

3. The plastic injection molding station as set forth in claim 1 wherein said first member includes a first engaging portion adapted to engage a second member when said first member is in said engaged position.

4. The plastic injection molding station as set forth in claim 3 wherein said first member is located adjacent said first mold portion and said second member is located adjacent said second mold portion.

5. The plastic injection molding station as set forth in claim 4 wherein said first member includes a pair of moveable arms extending generally toward said second mold portions.

6. The plastic injection molding station as set forth in claim 5 wherein said first engaging portion is a shoulder formed generally toward one end of each of said arms.

7. The plastic injection molding station as set forth in claim 5 wherein said second member includes a pair of arms extending generally toward said first mold portions.

8. The plastic injection molding station as set forth in claim 7 wherein said arms of said second member are fixed in position relative to said second mold portion.

9. The plastic injection molding station as set forth in claim 7 wherein said arms of said second member include second engaging portions located generally toward ends thereof and adapted to retainingly engage said first engaging portions.

10. The plastic injection molding station as set forth in claim 1 further comprising a mold compensation assembly including a plurality of compensation members, said compensation members corresponding in number to the number of said mold cavities, said compensation assembly being coupled to the other of said first and second mold portions than said injection means, whereby said compensation assembly provides a compensation force at each of said mold cavities that is at least equal to an injection force provided by said injection means at each of said mold cavities.

11. The plastic injection molding station as set forth in claim 10 wherein said compensation members are pistons centered on each of said mold cavities.
